(19) United States
(12) Patent Application Publication
(10) Pub. No.: US 2022/0084186 A1
(43) Pub. Date: Mar. 17, 2022

(54) AUTOMATED INSPECTION SYSTEM AND ASSOCIATED METHOD FOR ASSESSING THE CONDITION OF SHIPPING CONTAINERS

(71) Applicant: Canscan Softwares and Technologies Inc., Montreal (CA)

(72) Inventors: Jennifer IVENS, Montreal (CA); Zheng LIU, Kelowna (CA); Bruce IVENS, Montreal (CA); Ali ABDULBASET, Montreal (CA)

(21) Appl. No.: 17/416,973

(22) PCT Filed: Dec. 19, 2019
(86) PCT No.: PCT/CA2019/051865

§ 371 Date: Jun. 21, 2021

Related U.S. Application Data
(60) Provisional application No. 62/783,824, filed on Dec. 21, 2018.

(51) Int. Cl. G06T 7/00; G06N 3/08; G06Q 10/08; G06V 10/82; G06V 10/764; G06V 10/98; H04N 7/18; G06V 10/24; G06V 10/25

(52) U.S. Cl. CPC G06T 7/0002; G06N 3/08; G06Q 10/0832; G06V 10/82; G06V 10/764; G06T 2207/10016; H04N 7/181; G06V 10/242; G06V 10/25; G06T 2207/20081; G06T 2207/20084; G06V 10/987

(57) ABSTRACT

An automated inspection method and system are provided, for identifying and assessing the condition of shipping containers. The method includes analysing images, each including at least a portion of one of the shipping container's underside, rear, front, sides and/or roof; detecting a container code appearing in at least one of said images; identifying, based at least on said plurality of images, one or more characteristics of the shipping container and determining a condition of the shipping container based on said physical characteristics identified, the container code and characteristics being determined by machine learning algorithms previously trained on shipping container images captured in various lighting and environmental conditions; associating said container code with said condition of the shipping container and transmitting the container inspection results to a terminal operating system.

### TECHNICAL FIELD

The present invention generally relates to the field of shipping or cargo containers, and more particularly to a system and method for automatically inspecting shipping containers and assessing their condition using machine vision.

### BACKGROUND

With the rapidly growing world population, international trade and globalization have become the foundation of the global economy. Shipping container maritime transport is the primary means by which general cargo is transported throughout the world. With over 38 million twenty-foot equivalent containers in the global fleet, the shipping container is one of the most important assets of international trade. Built to withstand some the world's most environmentally punishing conditions, the integrity of these large metallic boxes is often overestimated, resulting in portions of the container fleet being frequently under maintained. The processing of huge volumes of containers at port and rail terminals requires increasingly fast turnaround time leaving little to no opportunity for shipping container inspections. Container damages go unseen, leading to various harmful outcomes including health and safety issues, negative environmental impact and commodity losses.

When transferring a shipping container from one operator to another, before responsibility and the liability can be transferred, the operators must conduct a visual inspection of the exterior of the container. This visual examination involves the identification of such items as placards, door security seals and structural components.

The transportation industry has expressed a great need for improved methods and systems to allow faster cycling through terminal gates with improved assurance to shipping container cargo worthy readiness.

### SUMMARY

According to an aspect, an automated inspection system and its associated method are disclosed herein, to identify and profile shipping containers, and to assess their condition and physical integrity.

According to possible embodiments, the proposed system and method allow for predicting maintenance and managing of shipping containers. In a possible implementation, the system comprises image storage means for storing a plurality of images, each image including at least a portion of a given one of the shipping container's rear, front, sides and/or roof or top. The system also comprises processing equipment or processing device(s) executing instructions for (1) detecting container codes appearing in at least one of said images; (2) identifying, based at least on said plurality of images, one or more physical characteristics of the shipping containers and determining conditions of the shipping containers based on said physical characteristics identified; and (3) associating said container codes with said conditions of the shipping containers. The system also preferably comprises data storage for storing the processor-executable instructions and for storing said container codes, physical characteristics and conditions of the shipping containers.

Advantageously, container profiling through container code, label recognition and seal presence can facilitate the registration and tracking process of shipping containers. Container condition assessment and rating can also reduce the occurrence of accidents, negative environmental impact and commodity losses. The capability to anticipate the potential deteriorations of shipping containers can help optimize the logistical operations and minimize the downtime, for maximal commercial benefits.

The shipping container profiling and inspection system uses high-definition images captured with video cameras, located at container operation facilities. By analyzing the acquired images, the container profile information is identified and extracted from container alphanumerical codes, signs, labels, seals and placards. The container condition may also be rated according to the shipping container's physical characteristics, including discerned damages and missing parts. Some selective computation and processing can be conducted locally, with on-site servers, and a remote cloud-server architecture including web services cloud platforms can be used, for providing analytic functionalities. The resulting profiling and inspection information can be transmitted directly into the terminal's operating systems and deployed to the end users through web services and Apps on smart tablets, phones or other mobile devices.

According a possible implementation, an automated inspection method for assessing a physical condition of a shipping container is provided. The method comprises a step of analysing, using at least one processor, a plurality of images, each image including at least a portion of one of the shipping containers' underside, rear, front, sides and/or top. The method also comprises a step of detecting a container code appearing in at least one of said images. The method also comprises a step of identifying, based at least on said plurality of images, characteristics of the shipping container and assessing the physical condition of the shipping container based on said characteristics. The container code and characteristics are determined by machine learning algorithms previously trained on shipping container images captured in various lighting and environmental conditions. The method also comprises a step of associating the container code with the physical condition of the shipping container; and of transmitting container inspection results to a terminal operating system.

In possible implementations, detecting the container code and characteristics of the shipping container is performed using a framework for image classification comprising convolutional neural network (CNN) algorithms.

The container code identification can be performed whether the container code is displayed horizontally or vertically in said images. It is also possible to compare horizontal container code characters recognized in one of the images wherein the container code is displayed horizontally with vertical container code characters recognized in another one of the images wherein the container code is displayed vertically, to increase accuracy of the container code determination. When the container code is displayed vertically in an image, it is possible to isolate each character forming the container code and apply the convolutional neural network algorithms to each individual character.

In one possible implementation, when the container code is displayed vertically in an image, the container code can first be detected and cropped, and rotated by 90 degrees in a cropped and rotated image, whereby the container code is displayed as a horizontal array, on which a convolutional recurrent neural network (CRNN) is used to recognize the container code from the cropped and rotated image, the CRNN scanning and processing every alphanumeric character as a symbol to detect and identify the container code. Detecting of the container code preferably includes detecting an owner code, a category identifier field, a serial number and a check digit. Locating the container code is also preferably performed through image pre-processing and recognizing the container code through a deep neural network (DNN) framework.

In some possible implementations, identifying characteristics of the shipping container comprises identifying security seals on handles and cam keepers in said images. As an example only, identifying security seals can comprise a step of determining possible locations of security seals in at least one of the images showing the rear of the container to reduce search region and applying a classification model algorithm to recognize if a security seal is present or not in said possible locations. In some possible implementations, security seal types can be identified.

Furthermore, according to yet other implementations, characteristics of the shipping container preferably comprises identifying damages, labels and placards. The inspection method can include a step of training a deep neural network (DNN) framework to identify said damages, labels, placards and seals using a respective damages, labels, placards and security seals training dataset, and categorizing the damages, labels, placards and security seals according to predefined classes. Preferably, the deep neural network (DNN) framework is continuously updated as newly introduced damages, labels, security seals and placards are identified in the plurality of images. As examples only, the deep neural network (DNN) framework employs at least one: Faster R-CNN (Region-based Convolutional Neural Network); You Look Only Once (YOLO); Region-based Fully Convolutional Networks (R-FCN); and Single Shot Multibox Detector (SSD).

In possible implementations, identifying characteristics of the shipping container comprises identifying maritime carrier logo, dimensions of the shipping container, an equipment category, a tare weight, a maximum payload, a net weight, cubic capacity, a maximum gross weight, hazardous placards and height and width warning signs. Preferably, the method also comprises the identification of one or more of the following damages: top and bottom rail damages and deformations, door frame damages and deformations, corner post damages and deformations, door panels, side panels and roof panel damages and deformations, corner cast damages and deformations, door components and deformations, dents, deformations, rust patches, holes, missing components and warped components. Preferably, the identified shipping container damages are characterized according to at least one of: size, extension and/or orientation.

In possible implementations, the method includes steps of classifying the identified shipping container damages and of transmitting the inspection results to the terminal operating system. The inspection results are preferably provided according to ocean carrier guidelines, including the Container Equipment Data Exchange (CEDEX) and Institute of International Container Lessors (IICL) standards. Still preferably, the container code and associated shipping container condition can be provided or displayed through a website, a web application and/or an application program interface (API). When the inspection results are displayed on a graphical user interface, terminal checkers can validate the inspection results, and feedback provided through the graphical user interface can be used for adjusting the machine learning algorithms.

In possible implementations, the physical condition of the shipping containers over time can be logged, and their future conditions can be predicted, where the degradation of the condition of the shipping container is made as a function of time. Maintenance and repair operations on the shipping container can be scheduled, based on said physical condition determined.

In possible implementations, the plurality of images is captured with existing high-definition cameras suitably located at truck, railway or port terminals. The plurality of images can be extracted from at least one video stream captured from a high-definition camera. The plurality of images can be stored either locally, or remotely on one or more cloud servers, or in a mixed model where a portion of the images are stored and processed locally, and other portions are stored and processed remotely. For example, the images can be preprocessed and deblurred locally by edge processing devices, where the container codes are detected by said edge processing devices, and the container characteristics are identified by said edge processing devices and/or remote cloud servers. Additional images can be captured with mobile devices provided with image sensor(s), processing capacities, and wireless connectivity, including at least one of: a smart phone, a tablet, a portable camera or smart glasses.

In possible implementations, a virtual coordinate system based on the Container Equipment Data Exchange (CEDEX) can be built and associating coordinates with the container code and physical characteristics of the shipping container, according to said virtual coordinate system, to position said container code and/or physical characteristics in said virtual coordinate system.

The inspection method also preferably includes a step of rating the container's condition according to a quality index. A 2.5D image can be created from the plurality of images and displayed so as to include a visual symbol or representation of at least one of the characteristics of the shipping container, allowing damage visualization.

In possible implementations, a virtual 3D representation of the shipping container can be reconstructed, based on said plurality of images, using neural volumes algorithms.

According to another aspect, an automated inspection system is provided, for assessing the condition of shipping containers. The system comprises shipping container image storage for storing a plurality of images captured by terminal cameras, each image including at least a portion of a given one of the shipping container's rear, front, sides and/or roof; processing units or devices, and non-transitory storage medium comprising machine learning algorithms previously trained on shipping container images captured in various lighting and environmental conditions. The processing unit(s) execute instructions for detecting container codes appearing in at least one of said plurality of images captured by the terminal cameras; for identifying, based at least on said plurality of images, one or more characteristics of the shipping containers and assessing the physical conditions of the shipping containers, based on said characteristics identified, using the trained machine learning algorithms; for associating said container codes with said physical conditions of the shipping containers; and for transmitting container inspection results to a terminal operating system. The system also includes data storage for storing said processor-executable instructions and for storing said container codes, characteristics and conditions of the shipping containers.

The system preferably includes a framework for image classification comprising convolutional neural network (CNN) algorithms. The non-transitory storage medium can also comprise a horizontal code detection module, a vertical detection code module and a container code comparison module to identify the container code. In possible implementation, the system includes a handle and cam keeper detection module and a seal detection and classification module. Still possibly, the system can comprise a crack detection module, a deformation detection module, a corrosion detection module and a 3D modelling module. The system may also comprise a damage estimation module and a remaining useful life estimation module. In some implementations, edge computing processing devices are situated proximate to the terminal premises.

In some implementations, the data storage can comprise a shipping container database, for storing information related to shipping containers, including at least one of: container codes; labels, security seals, and placards models; types of shipping containers and associated standard characteristics, such as width, length and height. The data storage can store information related to shipping container damage classification and characterization parameters. It may also include an index for rating shipping container physical status, which includes physical damages and/or missing components.

In preferred implementations, the framework comprises DNN (Deep Neural Networks) based object detection algorithms. The system may also include one or more websites, web applications and application program interfaces (API) for transmitting and displaying the container codes and associated shipping container conditions. The system may also be used in combination with smart mobile devices to capture additional images and/or to augment visual imaging of human inspectors by displaying information relative to the damages detected.

### BRIEF DESCRIPTION OF THE DRAWINGS

FIG. 1 is a high-level flow chart of the shipping container inspection method, according to a possible implementation.

FIG. 2 is a schematic diagram of the components of an automated shipping container inspection system, according to a possible implementation.

FIG. 2A is high-level architecture diagram showing data transfer between terminal located components, remote processing servers, and terminal operating systems or web application graphical interfaces, wherein most image processing is performed remotely from the terminal, according to a possible implementation.

FIG. 2B is a high-level architecture diagram showing data transfer between terminal located components, remote processing servers, and terminal operating systems or web application graphical interfaces, wherein at least a portion of image processing is performed locally, by edge processing devices, according to another possible implementation.

FIG. 3 is a diagram showing some of the components and modules of the automated shipping container inspection system, according to a possible implementation.

FIG. 4 is a photograph that illustrates a possible camera installation used for inspecting shipping containers, for use with to the proposed inspection method and system.

FIG. 5 is a schematic diagram showing the use of smart glasses provided with cameras to acquire images of shipping containers, according to a possible implementation of the shipping container inspection system and method.

FIG. 6A is a rear perspective view of a standard shipping container. FIG. 6B is a front perspective view of the shipping container of FIG. 6A. FIG. 6C is an example of a container code, according to a possible industry standard.

FIG. 7 is a possible view of a graphical user interface, showing the rear of the container, with the container type, container code, warning placard, security seal and container capacity having been identified by the automated inspection method and system, according to a possible implementation.

FIG. 8 is a schematic workflow diagram showing processing of a container code displayed vertically on the shipping container, according to a possible implementation of automated inspection method and system.

FIGS. 9A to 9D are images captured by the cameras, showing different examples of cable and J-bar security seals having been identified by the automated inspection method and system.

FIGS. 10A and 10B are images captured by the cameras, showing different examples of snapper and bolt security seals having been identified by the automated inspection method and system.

FIGS. 11A to 11C are images captured by the cameras, showing different examples of common cable security seals having been identified by the automated inspection method and system.

FIGS. 12A and 12B are images captured by the cameras, showing different examples of common cable security seals having been identified by the automated inspection method and system.

FIG. 13 is a schematic workflow diagram showing processing of a rear-view image of the shipping container, for detecting and identifying security seals using customized convolutional recurrent neural networks, according to a possible implementation of automated inspection method and system.

FIG. 14 is another possible view of a graphical user interface, showing a shipping container being hoisted by a crane, the images having been captured by terminal cameras and processed by the shipping container inspection system, with door handles, cam keepers and security seals having been identified, for validation by a terminal operator.

FIGS. 15A to 15B are images captured by the cameras, showing different examples of side panels with corrosion patches having been identified by the automated inspection method and system.

### DETAILED DESCRIPTION

Shipping containers play a central role in worldwide commerce. Commercial transportation infrastructure is largely dedicated to the standards required of shipping containers for seagoing or inland vessels, trains and trucks. Shipping containers also represent significant assets of international shipping and global trade. As trade volumes increase, terminal inspectors have less time to conduct container quality inspections. The described system and method provide an automated shipping container inspection system, using high-definition cameras and machine learning algorithms.

The proposed system and method use two-dimensional (2-D) high-definition images of shipping containers, captured from video cameras located in strategic areas within terminal facilities. The system and method can create an information profile of each container by detecting the container code, model, type, application and other relevant information that can be found on labels, seals, signs and placards provided on the container's surfaces. The system and method assess physical characteristics of the shipping container, including damage type and the extent of damages. In some implementations, the system and method can also anticipate deterioration and provide maintenance guidance to prevent and/or limit further degradation. By including predictive maintenance tools, the system and method described herein can help reduce the occurrence of accidents and minimize environmental impact a well as optimize logistical operations for partnering facilities. In predictive maintenance, advanced analytics and machine learning techniques are used to identify asset reliability risks, by anticipating potential damages that could impact business operations.

Various embodiments are described hereinafter with reference to the figures. It should be noted that the figures are not drawn to scale, and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with an embodiment is not necessarily limited to that embodiment and can be practiced in any other embodiments even if not so illustrated.

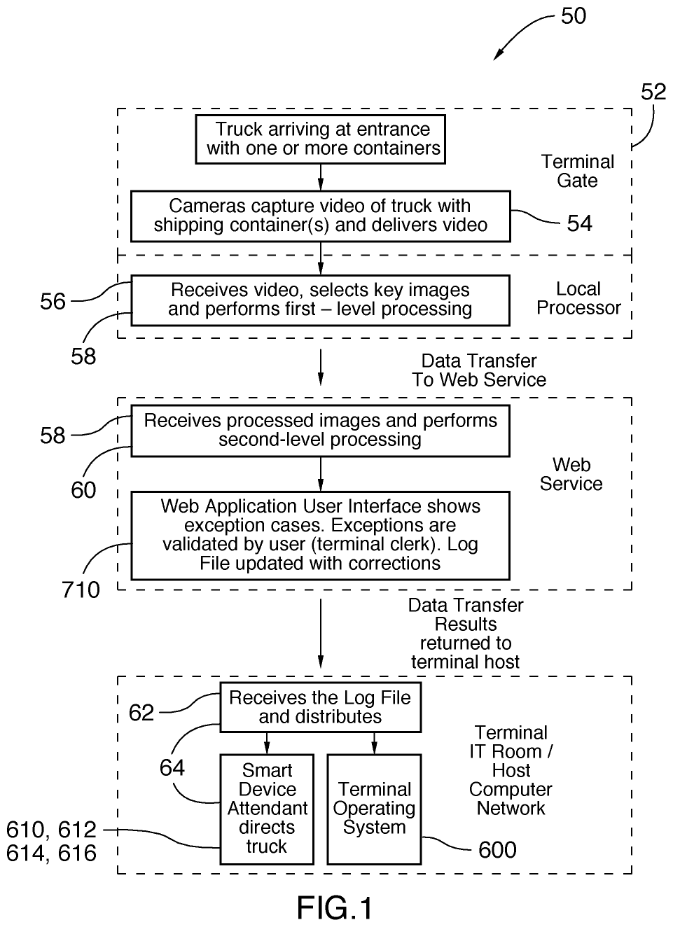

Referring to FIG. 1, a high-level flow chart of the inspection process is illustrated, according to a possible application. A container arrives on a truck at terminal (52) and video frames are captured by the terminal cameras (54), including images of the lateral, rear side and top side of the container. An edge processing device receives the video frames and selects key frame images (56) from the video stream, to limit upload size and cost. The selected images are then uploaded to a computational/analytical platform. Container profile data is extracted from the images and an identity for the container is created (58). Physical condition is then extracted from the images and recorded (60). A container data log is created, combining the container profile or identification and condition assessment. The inspection results are sent back to the host computer (62), typically part of the main office monitoring station in the terminal. Inspection results can be sent to smart devices to inform terminal checkers if the truck can continue its route or not (64).

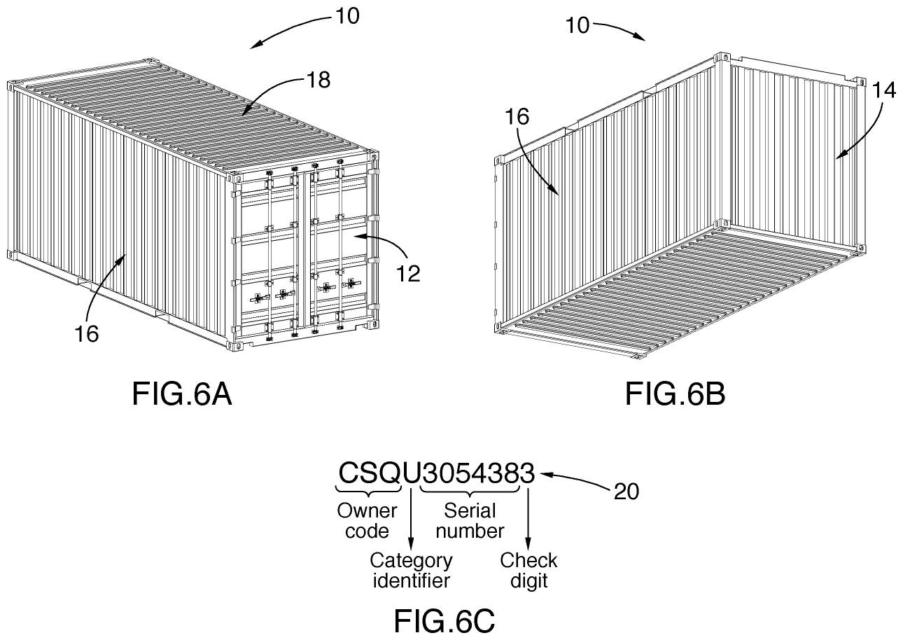

In the present description, the term “shipping container” refers to shipping containers suitable for shipment, storage and handling of all types of goods and raw material. They are also referred to as “cargo containers” or “intermodal shipping containers” and are typically closed rectangular containers having a length of 24 or 40 feet (6.1 or 12.2 m) and heights between 8′6″ (2.6 m) and 9′6″ (2.9 m). The support frame is made from structural steel shapes and wall and door surfaces are made of corrugated steel. Other container shapes and configurations are available for unusual cargo. FIGS. 6A, 6B, 7 and 14 show different views of standard containers and container components.

The automated shipping container inspection system described hereinbelow detects and identifies, using images captured by any suitable existing or new, terminal cameras, shipping container codes and shipping container characteristics including labelling, security seals and damages, and assesses, based on said characteristics, the physical condition of the shipping containers. In some implementations, the system can also categorize the container damages and predict maintenance operations based on the determination of the container's condition. In order to effectively recognize container characteristics, the disclosed system is trained with a variety of shipping container images of different physical conditions, and comprising codes, logos, signs, placards and labels. The set of images used to train the machine learning algorithms are captured in various lighting and environmental conditions, i.e. at daytime and nighttime, and during sunny, rainy, snowy and foggy conditions. For detecting the presence of security seals, machine learning algorithms are also used, trained on image data sets of different container rear sides, where seals of different types are affixed at varying locations onto the container doors.

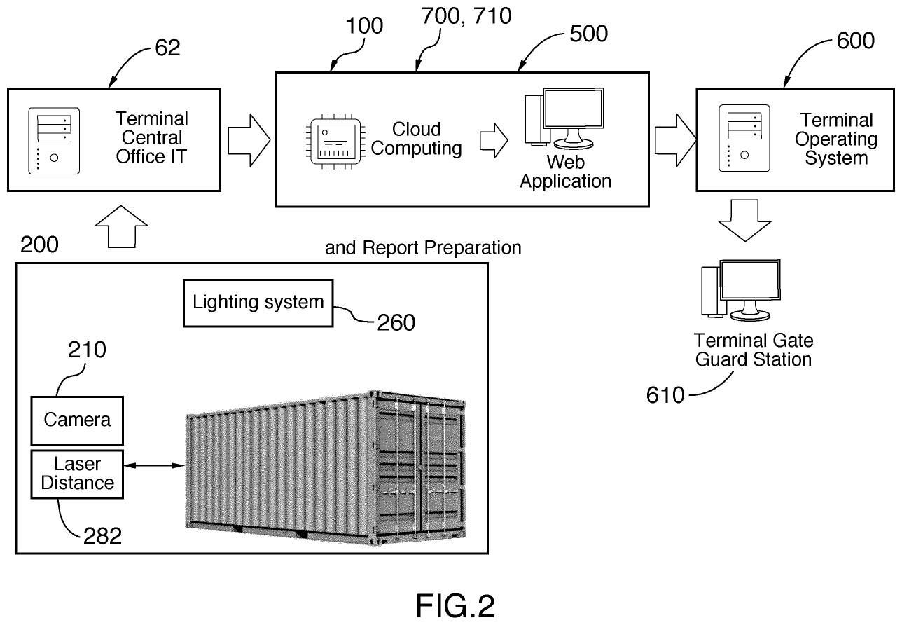

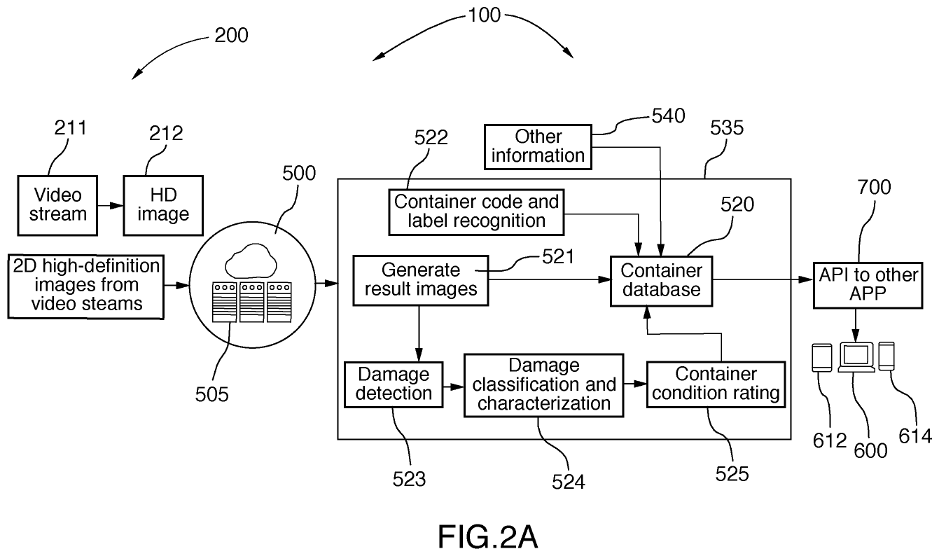

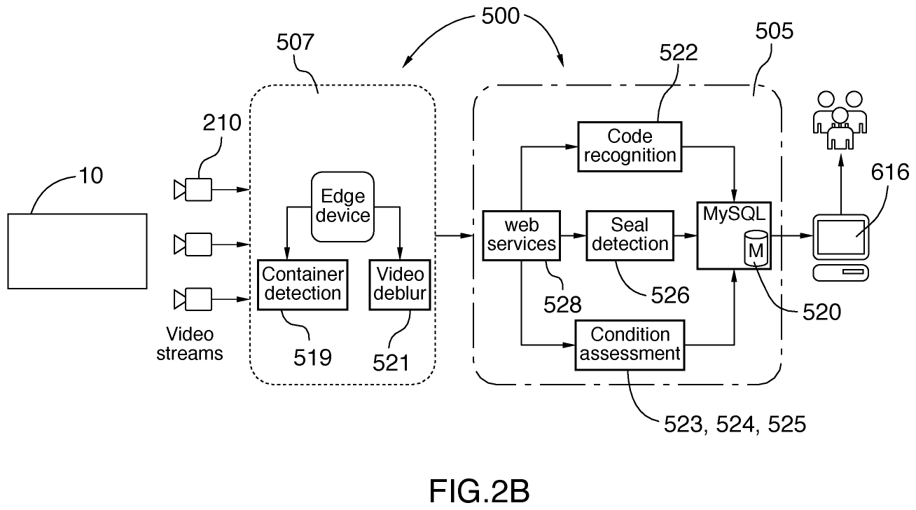

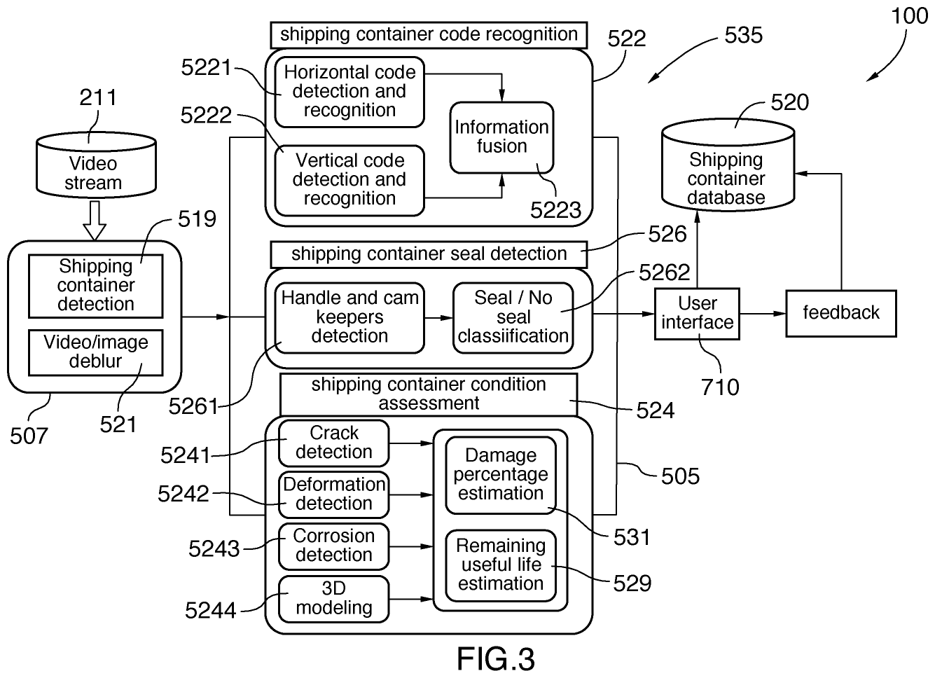

The overall architecture of the proposed automated shipping container inspection system 100 is illustrated in FIGS. 2, 2A, 2B and 3, according to possible implementations.

Referring to FIG. 2, the system 100 comprises at least a cloud-computing platform 500 and a front-end application 700. The cloud computing platform 500 interacts with a terminal image acquisition system 200 and with the terminal operating system 600 of the terminal owner. Depending on the implementations, components of the image acquisition system 200 and of the terminal operating system 600 can be part of the shipping container inspection system 100.

### Image Acquisition

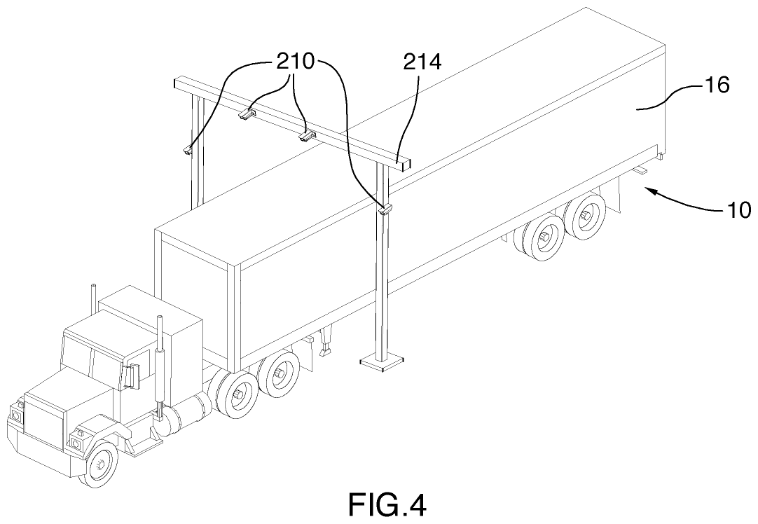

Still referring to FIG. 2, and also to FIG. 4, the image acquisition system 200 includes one or more high-definition digital cameras or image sensors 210, 210′, to capture images of the containers 10 being inspected. The cameras 210, 210′ are preferably positioned and located on a purpose-built structure or frame 214, such as shown in FIG. 4, to capture images of at least one of the shipping containers' sides 16, rear and/or front ends, and top and/or bottom sides. The cameras can be video cameras 210 that continuously capture images as part of a video stream 211, or single frame cameras 210′ that capture only a few images and/or specific regions of the shipping containers 10. In both cases, high-definition images, preferably at a minimum of 1080 pixels, are generated. Preferably, the inspection system 100 does not require the installation of additional cameras and/or of specific positioning systems for the cameras, as is the case with other existing inspection systems. The computational platform 500 is adapted and configured to work with container images captured with existing high-definition terminal cameras, such as security cameras for example, suitably located at truck, railway and port terminals. Cameras on gantry cranes, used for moving the containers, can also be used. According to a possible implementation, the sensor components can be arranged in arrays to provide imaging in organized groupings. For example, a group can focus on all door structural details while a second sensor array may focus on door closure and evidence of an applied security seal. Of course, components can be grouped differently without departing from the present invention.

The multiple cameras are preferably calibrated first to account for their position and the resulting effect on optical properties and image reproduction. The calibration of the cameras can be implemented with the build-in functions of OpenCV (OpenSource Computer Vision Library), although other calibrating methods are possible. According to a possible implementation, a calibration object is used which for example could be represented by a chess-board pattern which displays in the image radial and tangential distortion which must be considered. According to another possible implementation, calibration of the cameras can be achieved using the shipping container in the images directly by selectively choosing reference components. Again, several approaches can be considered to estimate the corrections required to the photograph. According to a first possible approach, the position or pose estimation is made using a single camera or as a second approach, using multiple cameras with Sylvester's equation.

### Virtual Pattern

Still referring to FIG. 2, a quantitative evaluation of the physical status of shipping containers against predefined dimensional standards can be facilitated by using reference lines, in the form of a virtual pattern scribed over container surface images, against which programming will determine relative distances between reference pattern lines and selected container physical surfaces or points. Initially, the virtual pattern can be produced with the addition of engineered filters on a camera lens. With further development, the virtual pattern may be provided from programming within an image processor. A scaling factor can be determined by continuous optical comparison of camera reticle gridlines with known dimensional elements on each container. The resulting scale factor can then be applied to the relative distances determined, to produce a quantitative value in form of meters or percentages. In alternate embodiment, laser markers 280 can be projected onto the container, when being filmed by the cameras 210, 210′ 210″. If needed, profiling camera lights 260 can be added to improve observable image details.

### Terminal Operating System

Still referring to FIG. 2, a local processing device 610 is part of, or interacts with, the terminal operation system 600. The local processing device 610, via a front-end application 700 part of the inspection system 100, receives all camera images and selects key frames according to predefined criteria. The selecting of key images can be made by terminal operators, or automatically, by the front-end application 700. The objective is to filter images and select those that comply with predetermined criteria such as a set number of images that display a particular laser light pattern or points on the container surfaces, so as to provide a reference for positioning features and components detected by the system and for calibrating the cameras. These images will convey sufficient information for the following step. To address other potential quality issues such as ambient lighting, imaging with near-infrared light may be considered for those most challenging inspection tasks and from which the produced image is not visually useful to the human eye unless mapped with numerical coordinates.

These Key Frame Images (KFI) can then be preprocessed locally or alternatively sent to a cloud-based image processing system 500. Where existing shipping facility cameras are available at no less than 1080p, they can be repurposed for profile generation and condition assessment with the present inspection system 100. In other implementations, a dedicated acquisition system with high resolution cameras can be used, adapting machine vision cameras (above 5 megapixels) with specialized lenses to broaden and improve shipping container condition assessment. In the embodiment presented in FIG. 2, the image acquisition system 200, including the cameras and related components, forms part of the inspection system 100. However, it can be considered that the shipping container inspection system accesses images from an intermediate image storage subsystem. The images of the shipping containers can thus be provided by a third party, such as through existing terminal cameras already in use at container terminal ports, railway and truck facilities, and used for other purposes.

As will be described with reference to FIGS. 2A and 2B, image storage and initial image processing can be performed locally, at or near the terminal premises, as in FIG. 2B, or alternatively, the image storage and preprocessing can be conducted remotely, through cloud-based servers, where most of the image processing is realized, as in FIG. 2A. The image storage and processing can also be distributed between local and remote servers and/or databases, depending on the processing and network capacity at the terminals, and/or for data security reasons. The back-end system 500 may thus include a single local server, or a cluster of servers, remotely distributed, as part of a server farm or server cluster. It will be noted that the term “server” encompasses both physical and virtual servers, for which hardware and software resources are shared. Clustered servers can be physically collocated or distributed in various geographical locations. Servers, or more generally, processing devices, include memory, or storage means, for storing processor-executable instructions and software, and processors, or processing units for executing different instructions and tasks.

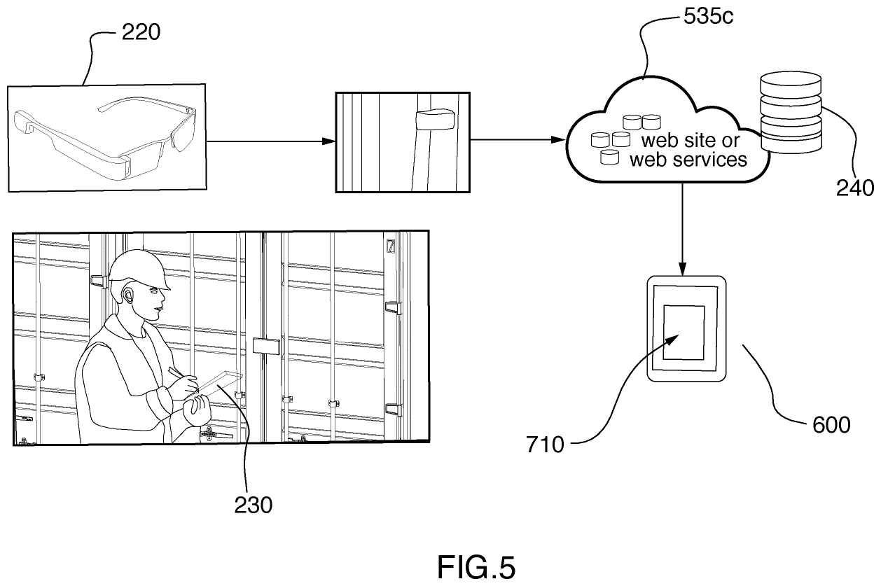

According to a possible implementation, the image acquisition system 200 can further include portable devices 220 and/or 230, examples being shown in FIG. 5, offering both a camera and a screen display with wireless connectivity. Human inspectors may carry a mobile tablet or smart phone to supervise the container imaging process and when necessary, to provide additional images of damage captured by the main cameras 210 but requiring further verification.

### Image Processing and Computational Platform

Still referring to FIG. 2, image processing is preferably mostly carried out on cloud-based servers 500, using machine learning and artificial intelligence (AI) algorithms, including customized functions from third party's web services. Different software modules are provided as part of a back-end system 500, in order to detect, identify, and characterize container damage, as will be explained with reference to FIG. 3. According to a possible embodiment, Amazon's Web Services (AWS) can be employed to perform some of the image data analysis. For stream video data analysis, Amazon Lambda and Kinesis can be considered in the implementation as well. Of course, other similar platforms can be used instead, such as: Google platform, Microsoft Azure, and IBM Bluemix. Although the Amazon AWS platform can be used, the inspection system can be implemented using a serverless pipeline for video frame analysis, to balance the data volume, computational needs, communication bandwidth, and available resources.

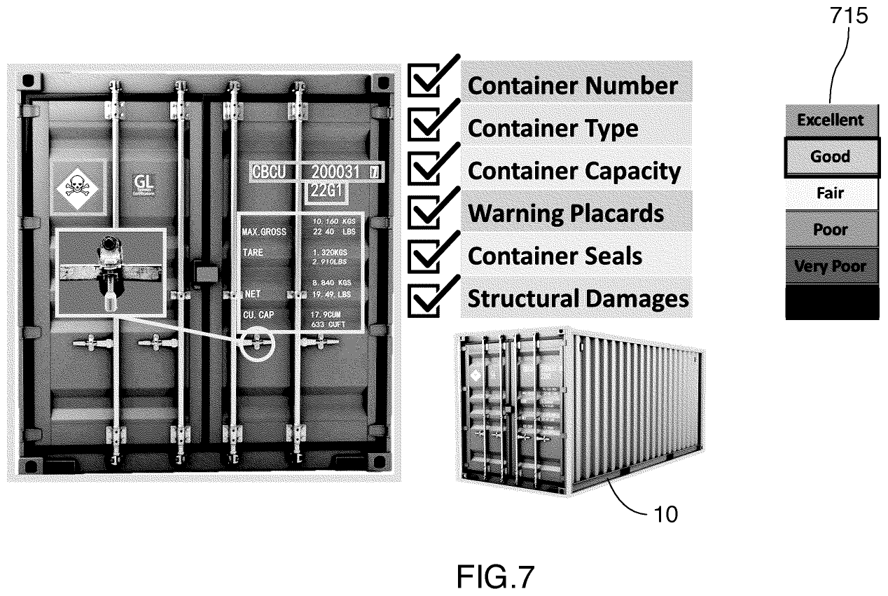

Still referring to FIG. 2, and also to FIG. 7, a rating for the container's condition can also be determined based on the derived evidence with respect to organizational benchmarks, such that the system can rate shipping containers according to a quality index 715. A shipping container reference database may be included as part of the back-end system 500, to store baseline container codes, types of damages, condition ratings, and other information on standard undamaged containers for comparison purposes, etc. The printed information provided on the shipping containers, e.g., codes, labels, seals, and signs, is detected and recognized automatically with intelligent customized software modules and algorithms in the cloud. The terminal operators can be offered access to the information from deployed web or mobile applications and interfaces 710, via the front-end application 700.

### Remote Processing

Referring now to FIG. 2A, an architecture according to one possible implementation of the inspection system 100 is shown. In this example, 2D high-definition images 212 of shipping containers are extracted from video stream 211 and are transmitted to a cluster of servers and logics 500. The remote servers 505 are used for both image storage and for image processing. Key frame images are preferably selected locally, and the key frame image data is stored and processed remotely. In this case, the computational platform 535 comprises a preprocessing software module 521 to preprocess the images for deblurring, filtering, distortion removal, edge enhancements, etc. Once preprocessed, the images are analyzed for container code and label detection and identification, by software module 522. The processed images are also to be analyzed for damage detection, via module 523, damage classification and characterization, via module 524 and for container condition rating, via module 525. The container inspection results are then transmitted to the end users through web services or apps 700, on a tablet 612, smart phone 610 or desktop/laptop which are preferably connected to the terminal's central computer system 600, via a secured connection.

Inspection results can be provided in the form of files, such as spreadsheets, xml, tables, .txt, and include at least the shipping container codes, and a rating of the container's condition. Preferably though, the results are formatted according to existing freight container equipment data exchange guidelines, according to which codes and messages are standardized for container condition, repair condition, outside coating, full/empty condition, container panel location, etc. For example, a dent on the bottom portion of the right side of the container can be identified by “RB2N DT”, and if special repair is needed, the code “SP” is used, with the overall structural condition of the container being rated as “P”, for poor. The inspection system 100 can thus generate, almost in real time, using captured images from existing terminal cameras, and a fully customized and trained computational platform 535, inspection reports in a format that can be fed to, and used by, the terminal operating system 600, with no or very little human intervention. An exemplary shipping container is shown in FIGS. 6A and 6B, with the different container sides identified using the CEDEX coding standard.

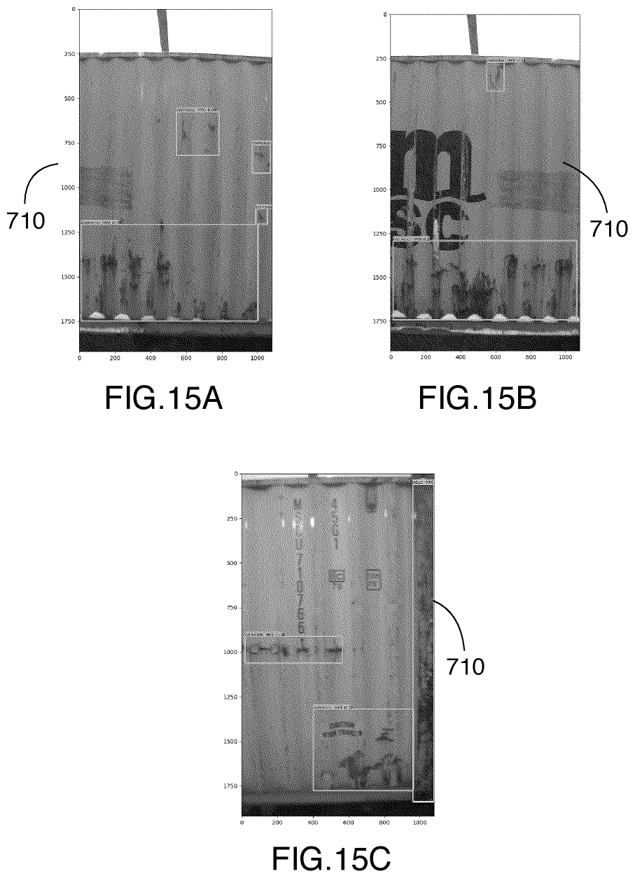

The inspection results can also be presented visually on a graphical user interface for consultation by terminal operators, where processed 2.5D images of the containers are displayed, with the damages highlighted and characterized by type, size, location, severity, etc., as per the examples of FIG. 15A to 15C.

### Edge and Remote Processing

Now referring to FIG. 2B, an architecture according to another possible implementation of the inspection system 100 is shown. Like the architecture of FIG. 2A, 2D high-definition images of shipping containers 10 are captured by existing terminal cameras 210, such as security cameras. However, in this case, edge processing devices 507 are used to detect containers in the images 519 and to preprocess the images 521. The remaining image processing and analyses are performed on remote, cloud-based servers 505, for code recognition 522, condition assessment via modules 523, 524 and 525, and also for seal detection 526. The analysis/inspection results are stored in data storage 520 (such as databases) and can be processed and sent to user terminals/computers 616, part of the terminal operating system 600. As will be explained in more detail below, the processing units/computational platform 535 comprises a framework for image classification including convolutional neural network (CNN) algorithms 528. In yet other implementations, it can be considered to have more image processing performed locally, on edge processing devices 507, to identify container codes, labels and placards, as examples only.

Referring to FIG. 3, a more detailed diagram of the main software modules of the shipping container inspection system 100 is shown, according to a possible implementation of the system 100. As explained previously, high definition 2D images are extracted from video streams 211 captured by video cameras at truck, port or rail terminals. Shipping container detection 519 and video/image deblur and processing 521 is performed on one or more edge or remote processing devices, which can comprise one or more servers, single board computers (SBC) desktop computers, dedicated field-programmable gate array (FPGA) cards, graphical cards, etc. The identification of container presence can be achieved with one camera, which faces the container directly. Alternatively, the presence can be confirmed with the container code recognition process. The processing image data is then sent to a cluster of servers 505, which can be locally or remotely located relative to the terminal, and which comprises the computational platform 535 that processes and analyses the image data, using machine learning and AI algorithms.

### Container Code (Alpha-Numeric Characters) Detection

More specifically, the computational platform 535 comprises a shipping container code detection/recognition module 522. The proposed shipping container code detection/recognition method relies on a deep learning AI framework 522 that uses a neural network architecture which uses feature extraction, sequence modelling and transcription. The shipping container code recognition module 522 detects a text region and uses a customized deep convolutional recurrent neural network to predict the container character identification sequence.

Referring now to FIG. 6C, an example of a shipping container identification code 20, consisting in an eleven (11) alphanumeric code, as designated under ISO 6346 (3^{rd} edition) is shown. Every shipping container has its own unique identification code. The container code includes an owner code, a category identifier field, a serial number and a check digit. The shipping container identification code is typically shown horizontally on the rear, top and occasionally at the front, while the left and right sides show the container code arranged vertically. There are many difficulties in shipping container detection and identification, such as irregular corrugation of the side panels, different illumination and varying weather conditions. While there are some developments for automatic horizontal text detection and recognition, such as text detector and/or OCR web services, these designs cannot detect the vertical codes of shipping containers.

Referring back to FIG. 3, the shipping container code recognition module 522 comprises, according to a possible implementation, a horizontal code detection module 5221, a vertical detection code module 5222, and a container code comparison module 5223 to increase accuracy of the container code identification. Given that same container code is generally displayed both horizontally and vertically, code determination on the different container panels can be compared to increase accuracy of the final code determination. Identification of the container code is thus performed whether the container code is displayed horizontally or vertically in the images. The container code detection module allows detecting the owner code, the category identifier field, the serial number and the check digit. For images where the container code is displayed vertically, the characters forming the container code are isolated and a convolutional neural network algorithm is applied to each individual character. For both horizontal and vertical container codes, detecting the code includes the general steps of locating the container code through image pre-processing and using a connected component labelling approach, and a step of recognizing the container code, using a deep neural network (DNN) framework.

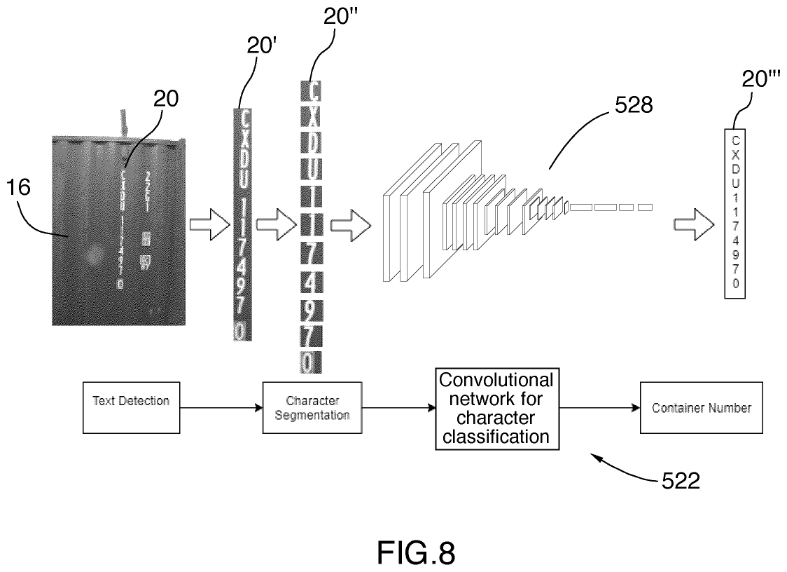

Referring to FIG. 8, a vertical text detection and recognition method is proposed for identifying shipping container codes 20 displayed vertically on side panels 16. The vertical text detection and recognition module 5222 is used for determining container codes displayed vertically. In one possible implementation, detection begins by locating the characters on the container surface and identifying the character orientation (vertical or horizontal). This process is implemented through a scene text detector. After detecting the position of the shipping container code 20, the specific area of shipping container code is cropped 20′. Then, characters in the code area are separated by related characters 20″. Finally, the individual characters of each code type are recognized one by one, using for example a visual geometry group (VGG) convolutional neural network, resulting in the determination of the container code 20′″.

As mentioned previously, the vertical 11-digit shipping container code generally appears on the left and right side panels of the container. According to another possible implementation, images taken from these two sides can be used as the input for the vertical code detection and recognition system. The shipping container code recognition module comprises in this case of two modules: the first module is a code detection submodule, and the second module is for code recognition in the detected area.

In the first module, a deep learning model based on U-Net and ResNet can be used to accurately locate the vertical 11-digit shipping container code. The output of the model is a rectangle bounding box, which can capture the shipping container code. Then, the detected code area is cropped as input for the second module. In the second module, the cropped image is first rotated by 90 degrees anticlockwise. Thus, the code permutation changed from a vertical array to a horizontal array. Then, a convolutional recurrent neural network (CRNN) can be used to recognize the code from the rotated image. The CRNN scans the rotated image from left to right and treats every alphanumeric character as a symbol. When CRNN detects a symbol, it outputs the corresponding character or number. Finally, the recognition module gives the 11-digit shipping container code sequence.

### Placards and Signs Detection

Referring back to FIG. 3, placard and sign recognition requires a predefined classification process, for which module 522 can be used. Thus, a training procedure can be employed to train the deep neural network (DNN) model, to identify multiple placards and signs. According to a possible implementation, the DNN will use a labelled training dataset, which references the categories of the pre-defined classes. Preferably, the placard and sign model is updated prior to new classes being posted on the rear end of containers, rendering training a new model from scratch, unnecessary.

### Security Seals Detection

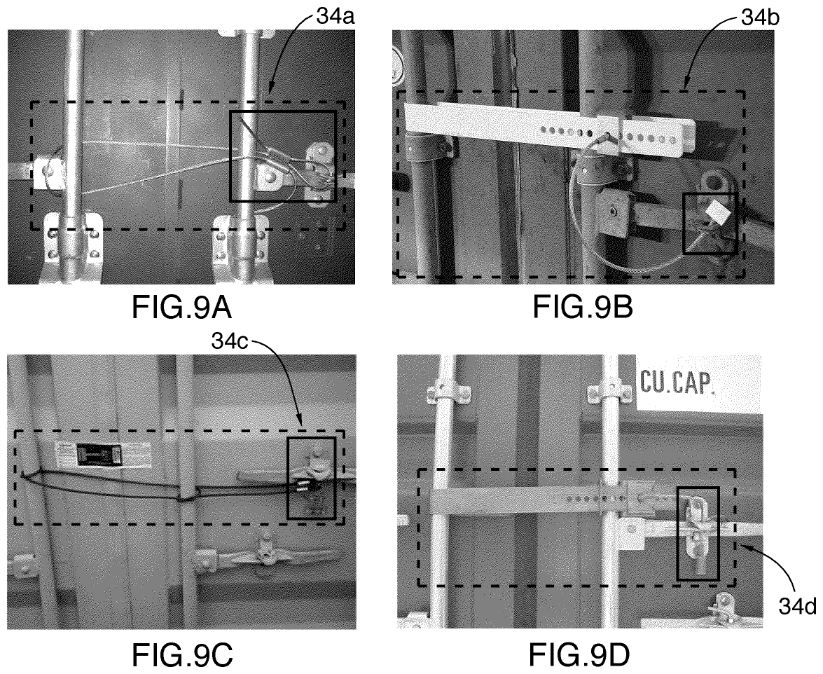

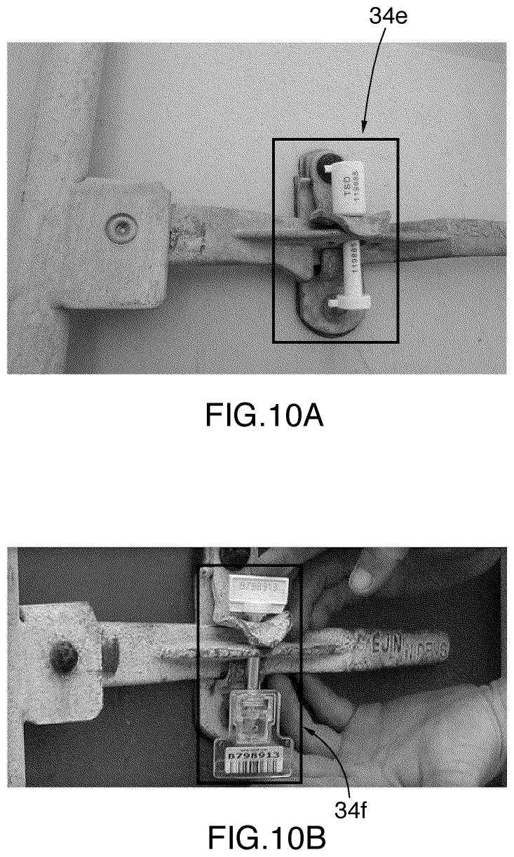

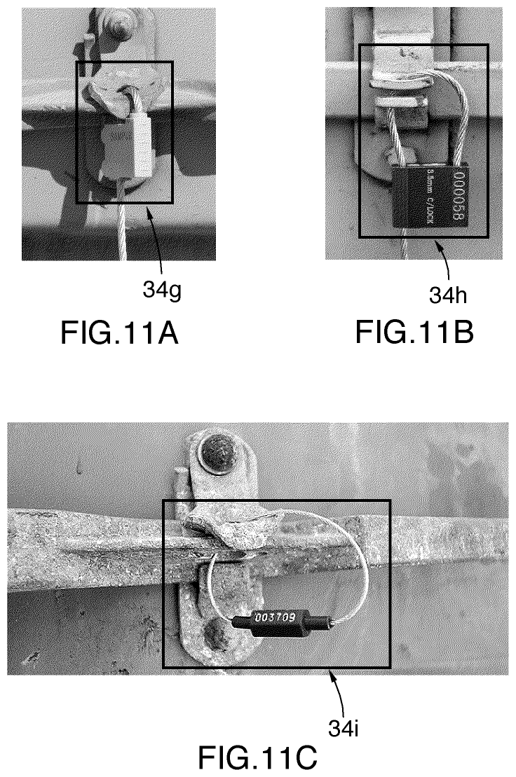

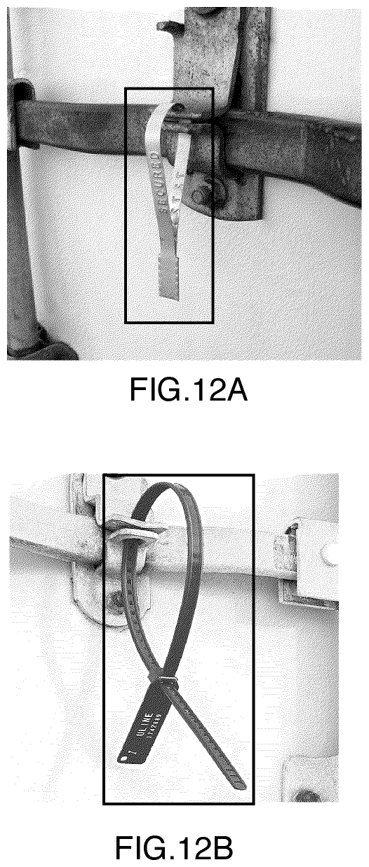

Still referring to FIG. 3, the computation platform 535 further comprises a shipping container seal detection module 526, for identifying security seals on handles and cam keepers in the shipping container images. Recognition of security seals is achieved by first determining possible locations of security seals in at least one of the images showing the rear of the container, to reduce searching region and by applying a classification model algorithm to recognize if a security seal is present or not in said possible locations. When image resolution allows it, the detection module 526 can also identify security seal types. Examples of different security seals 34a to 34i are illustrated in FIGS. 9A to 9D, FIGS. 10A and 10B, FIGS. 11A to 11C, and FIGS. 12A and 12B. In the exemplary implementation of FIG. 3, the shipping container seal detection module 526 comprises a handle and cam keeper detection module 5261 and a seal detection and classification module 5262.

Detection of security seals is quite challenging since they can be positioned on handles and/or cam keepers, and since their geometry/physical aspect varies greatly from one type of seal to another. They may also include chains and cables, as per the examples shown in FIGS. 9A to 9D, which makes it even more difficult to detect consistently, since the same seal type can take different configuration depending on how the cable or chain has been affixed to the door handles or cam keepers. Container security seals are typically fixed at eight (8) possible locations on a standard shipping container door: 4 handles and 4 cam keepers. According to a possible implementation that proved to be both computationally efficient and accurate, the shipping container seal detection module 526 first identifies the container within an image and creates a boundary box around it. Then within that boundary box, the system, via handle and cam keeper detection module 5261, identifies the 8 possible locations of a seal and creates a boundary box around each of them. The trained seal detection and classification module 5262 then determines if the area within the box matches its extensive training which has been done on a “no seal present” basis. Where a box contains something other than handle and cam keepers, the image is then mathematically processed to determine if the non-compliant part of the image corresponds to a security seal. According to a possible implementation, the module 5261 can also be trained to detect primary seals which typically comprise the locking mechanism, and to detect the secondary seals, which include chains and cables.

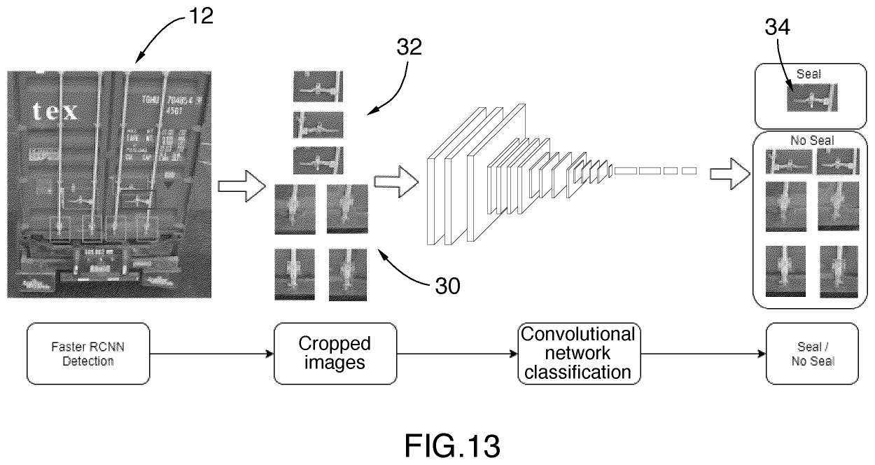

Referring to FIG. 13, an exemplary method of automatic detection of container security seals is schematically illustrated. Every shipping container must have a security seal locked in the correct position to ensure the cargo is safe. In order to detect whether there is a seal lock at the back door of the shipping container, the handle and cam keeper detection module 5261 first detect the possible locations using a customized Faster R-CNN algorithm. These possible locations include the area of door handles 30 and cam keepers 32. Then, the trained seal detection and classification module 5262 uses customized classification models, such as VGG and Resnet, to recognize if there is a locked seal 34 in the smaller regions of interest near handles and cam keepers.

Still referring to FIG. 13, in the first step, the customized Faster R-CNN model is employed to identify the region of interest including handlers and camp keepers on the back door of shipping containers in a compact area. The image is captured by the machine vision system at the portal. In the second step, an attention-based VGG16 classification network is adopted to identify the presence of the seal from the detected region of interest. This detection offers an automated end-to-end solution, which takes shipping container images as input and gives a binary output indicating the presence of the seal. The detection is robust and performs well in varied weather conditions.

To improve the security seal classification performance, training data is continuously fed to the seal detection and classification module 5262, and different deep learning models can be combined to recognize the security seals in the smaller cropped image area. Examples of deep learning models include STNs, and different versions of Resnet and Attention Mechanism. Security seals are particularly challenging, since the are relatively small objects relative to the size of the shipping container rear doors.

In a second possible implementation, and only when image resolution allows it, instance segmentation with deep learning can be applied to the full door/rear image. Individual zones are identified where a seal may be located, with each potential zone being then provided with a unique ID or mask layer. The zones are then mathematically processed, such as with AI algorithms, to determine if a security seal is present.

### Shipping Container Condition Assessment

Referring again to FIG. 3, the computation platform 535 comprises a shipping container condition assessment module 524. Shipping containers might get damaged during transportation. Shipping containers are expected to have valid certification before assessment with the proposed method and system. For international travel, CSC Plates (Convention for Safe Containers) would be typical and for domestic use a certification such as or similar to Cargo Worthy (CVV).

A partial list of damages associated with specific shipping container components are listed here in Table 1 below:

TABLE 1
Partial List of the possible container
damages detected by the system

| Container Side | Part | Condition |
|---|---|---|
| Roof | Top rail | Deformation |
| | Roof panel | Dents/damages |
| | Open top container | Deformation |
| Corners | Post | Deformation |
| | Castings | Cracks/cuts/rust |
| Sidewalls | Side panels | Dents/damages |
| | Bottom rails | Dents/damages |
| Door | Frame | Deformation |
| | Assembly | Dents/damages |
| | Sill and cone protector | Deformation |
| | J Bar | Damages |
| | Hinges | Missing/warped/rusted |
| | Door head, roof extension | Deformation |
| | plant | |
| | Handle | Missing/warped/rusted |
| | Lock rods | Missing/warped/rusted |
| | Cam keepers | Missing/warped/rusted |
| | Cam | Dents/damages |
| | Guides and brackets | Missing/warped/rusted |
| | TIR plate/lock box | Missing/warped/rusted |
| | Handle hub | Missing/warped/rusted |
| | Catch and retainer | Missing/warped/rusted |
| | Rubber door gaskets, tears | Missing/warped/rusted |
| | and cuts | |

To assess the overall integrity condition of the shipping container, the damage type is recognized, and the damage level of the shipping container is estimated. Types of damages can include for example dents, deformations, and rust. The computation platform 535 comprises a trained and customized Faster R-CNN model that detects the area of the damaged parts. Then, an adaptive image threshold method is used to isolate the image pixels of the damaged parts, in order to identify the type and extent of the damage. This output data is then used as the basis of the predictive cost and repair scheduling model.

The shipping container condition assessment module 524 has been developed to accurately detect and quantify the damages by deriving the damage contours. This module takes images from the left, right, top, and backside/rear of the shipping container to acquire comprehensive information on the damages. The overall detection system consists of two modules: damage localization and condition assessment. The first module is implemented by the instance segmentation model, which is built on Mask R-CNN (region convolutional neural network). The instance segmentation model outputs the edge contours of the damages. The second module removes the weak damages and wrong predictions and then makes a final assessment of the shipping container. This module takes the damage type and damage location information as inputs. First, the wrong predictions (false alarm) are removed by the damage classification model, i.e., ResNet. Then, adaptive thresholds are applied to the damaged area to remove the “weak” damages, which are treated as damages to the shipping container. For instance, small dents will not be considered as damage as they do not affect the condition. However, small holes should be counted as damage. Finally, the total damaged area is calculated to estimate the severity of the damage. The condition assessment module finally generates reports of the severities and locations of different kinds of damages.

In the exemplary implementation of FIG. 3, the shipping container condition assessment module 524 comprises within the damage localization module: a crack detection module 5241, a deformation detection module 5242, a corrosion detection module 5243 and a 3D modelling module 5244. The deformation detection module 5242 is trained and configured to identify one or more of the following characteristics of the shipping container: top and bottom rail damages and deformations, door frame damages and deformations, corner post damages and deformations, door panel, side panel and roof panel damage and deformations, corner cast damages and deformations, door components and deformations. The crack detection module 5241 and the corrosion detection module 5243 are trained and configured to identify dents, rust patches, holes, missing components and warped components. A damage estimation module 531 has been developed and can qualify the identified shipping container damages according to their size, extension and/or orientation. For example, the extent of the damage can be expressed as a ratio of the damage area relative to the surface area of the shipping container panel.

### 3D Reconstruction

With regard to the 3D modelling module 5244, the inspection assessment method can include a step of conducting a “3D reconstruction” of the shipping container being inspected, to achieve the depth or topographic information of container surfaces, i.e., surface details and damages. Herein, “3D reconstruction” refers to more general reconstruction of surface profile, rather than the same terminology as used in the computer vision research community.

In the exemplary implementation shown in FIG. 4, four cameras 210 are provided for left-side and right-side views, a top view and a back/rear view. The structure from motion (SfM) algorithm can be employed for 3D reconstruction using only 2D images or video sequences, where multiple overlapping input images are required. Possible 3D reconstruction methods include the DeMoN (Depth and motion network for learning monocular stereo), SfM-Net (SfM-Net: Learning of Structure and Motion from Video), and CNN-based SfM (Structure-from-Motion using Dense CNN Features with Keypoint Relocalization) methods, which are based on deep learning.

### Corrosion Detection and Quantification

With reference to FIG. 15A to 15C, different images with rust patches identified by the automated inspection system are shown, with bounding boxes surrounding the patches, each bounding box comprising an indication of the type of damage identified (in this example, rust) and the extent/area of the rust patch relative to the surface of the container's panel. The shipping container condition assessment module 526 can generate, for display on a graphical user interface, a 2.5D image created from the captured images and including a visual symbol or representation of at least one of the characteristics of the shipping container (such as damage type), allowing damage visualization.

Still referring to FIGS. 15A to 15C, and also to FIG. 3, the corrosion detection and quantification module 5243 provides an estimation of the corroded area on the shipping container surface. In a first step, the sequence of shipping container images captured by the machine vision system at the portal is processed with a background subtraction method to get the body (region) of the shipping container. In a second step, a Fast R-CNN model is employed to detect the corrosion regions on the surface of the shipping container. The output of object detection are the bounding boxes containing corroded areas. Then, image processing techniques, e.g., Gabor filter and image segmentation, are applied to the bounding box to extract the accurate corroded area. In a third step, to quantify the actual size of the area, the pixel-based scale is mapped to the actual size (in square meter) by matching the length or height of the shipping container to its actual length or height. The actual size of a shipping container can be obtained from its type. The length or height of the shipping container can be derived from the segmented image from step one. In the scenario, where only part of the container is shown in one image, the image stitching of a continuous image sequence will be applied to obtain a complete shipping container from multiple images. The edge to edge length is presented by the number of pixels and thus can be mapped to the actual size.

This is an end-to-end solution that takes shipping container images as input and output the real size of corrosion damages. The outputs can be further used to rate the condition of the shipping container.

### Augmented Visual Imaging

With reference to FIG. 5, smart mobile devices 220 can be used to capture additional images by terminal checkers, if needed, but can also be used to augment visual imaging of the terminal checkers, by displaying information relative to the damages detected. For example, parameters of the damages (type, size, severity degree) can be displayed within the field of view of the terminal checker, in order to assist in evaluation whether the condition of the shipping container is adequate or requires corrective action/maintenance. Other mobile devices provided with image sensor(s), processing capacities and wireless connectivity can also be used, including smart phones, tablets and portable cameras. The following technologies can also be considered:
RGB-D camera and stereo vision: according to a possible implementation, an Intel RealSense depth camera can be used. The Bumblebee stereo camera from FLIR is another option to provide the depth measurement. The damages can be segmented from the detailed depth image based on the local topographic profile in terms of the general good surface condition.
Laser scanner: laser-based scanning may provide high-resolution results and provide instant position calibration for the imaging process.

Automatic container inspection can be performed using the modules described above with reference to FIG. 3, and for containers for which the condition has been assessed as “poor”, terminal checkers can be sent to the containers' location in the terminal to complement visual inspection of the container by taking additional images with a smart mobile device 220 and/or for confirming the condition of the container. Terminal checkers can generate inspection notes and can transfer the captured images, with or without textual and/or audio comments, to the data repository 520 in the cloud. Embedded processors in the mobile device can enable fast screening of questionable damages to the container. Thus, the proposed method and system may help local inspectors to locate problems on the container rapidly and efficiently while sharing the images with a remote office which may provide necessary support to the decision-making process.

Referring again to FIG. 3, preferably, reporting of the containers physical parameters is provided according to ocean carrier specified guidelines such as CEDEX or IICL. The remaining useful life estimation module 529, which performs predictive modelling for damage repair scheduling and cost control, also provides the inspection results in line with shipping industry guidelines, making the reporting structure suitable for different shipping and maritime logistics enterprises on different continents.

For damage detection, different deep neural network (DNN-based) object detection algorithms, as part of the shipping container assessment module 524, can be trained, customized and adapted, including for example You Look Only Once (YOLO), Region-based Fully Convolutional Networks (R-FCN) and Single Shot Multibox Detector (SSD). These models have different advantages of object detection. For instance, SSD and YOLO performs much faster than Fast R-CNN but may fall behind in terms of accuracy. The models can thus be combined and customized, where variations of SSD and YOLO models are used for real-time response, and a customized Faster R-CNN model is used for increased precision. For pixel-level damage prediction, adapted Segnet and Mask RCNN are used, where the Segnet module performs pixel-level segmentation, and the modified Mask RCNN model creates bounding box of detected objects and outlines the damage area by curved lines (mask) inside the bounding box.

Still referring to FIG. 3, the 3D modelling module 5244 can generate a virtual reconstructing of a 3D representation of the shipping container components based on the shipping container images, using neural volume algorithms. This encoder-decoder module learns a latent representation of a dynamic scene that enables reproduction of accurate surface information of damage level, such as the shape of the deformation area.

In summary, the computational platform 535, provided on remote servers 505, can identify several different characteristics of shipping container, including damages, labels and placards. For labels and placards, module 522 can be used by previously training the neural network model. Training of the deep neural network (DNN) framework is achieved by feeding the framework with respective damages, labels, placards and security seals training datasets, and by categorizing the damages, labels, placards and security seals according to predefined classes. During live shipping container inspections, the deep neural network (DNN) framework is continuously updated as newly introduced damages, labels, security seals and placards are identified in the images analyzed, such that the inspection results are improved in near real time. As mentioned previously, the deep neural network (DNN) framework comprises a plurality of customized models, trained on specific shipping container images, including, for example: Faster R-CNN (Region-based Convolutional Neural Network); You Look Only Once (YOLO); Region-based Fully Convolutional Networks (R-FCN); and Single Shot Multibox Detector (SSD). Given the corrugated and reflective nature of the metal panels, the neural network needs to be trained and customized according to the various lighting and environmental conditions during which the images are captured. The characteristics of shipping containers that can be detected and identified by the inspection system can include: maritime carrier logo, dimensions of the shipping container, equipment category, tare weight, maximum payload, net weight, cubic capacity, maximum gross weight, hazardous placards and/or height and width warning signs.

### Inspection Results

Still referring to FIG. 3, the inspection system 100 comprises one or more shipping container databases 520, for storing information relating to shipping containers, including for example container codes; labels, security seals, and placard models; types of shipping containers and associated standard characteristics, such as width, length and height. The data storage 520 can also store information related to shipping container damage classification and characterization parameters. It may also comprise an index for rating the shipping container physical statuses, including physical damages and/or missing components. In the data storage 520, container codes with associated physical condition of the shipping containers are stored and the container inspection results can be transmitted and displayed to terminal operating systems through the following channels: websites, web applications and/or application program interfaces (API).

The analytic results from the machine-based inspection can thus be stored in the database 520, in the cloud, and can be delivered to the end users through different APIs. Considering the end user environments, corresponding APIs can be provided for accessing the inspection results. With the derived quantitative information about the damages, the condition of the container can be rated based on established regulations, rules and experience. For example, when damage or conditions exceed a pre-set threshold, an alarm can be triggered to get the attention of the inspector. Subsequently, the inspector can perform a visual inspection using an augmented reality device, such as tablet or Google glasses. The device will lead the inspector to problem areas allowing for a rapid human made decision related to the container following destination and usage.

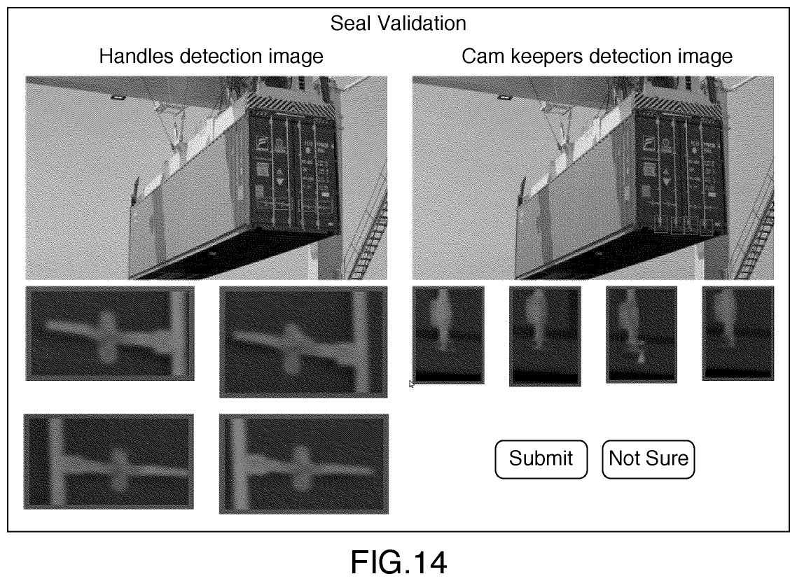

Referring to FIG. 3, and to FIGS. 4, 7, 14 and 15A-15C, the inspection results can be displayed on graphical user interfaces 710, for allowing terminal checkers to validate the inspection results. As best shown by FIG. 14, feedback provided through the graphical user interface 710 can be used for adjusting the machine learning algorithms.

Predictive Maintenance

Still referring to FIG. 3, the shipping container condition assessment module 524, through the shipping container database 520, can continuously log the physical condition of the shipping container over time. Using the previous logged conditions and/or damages, the remaining useful life estimation module predicts degradation of the shipping container's condition as a function of time. Using the CEDEX summary and applying cost related factors derived from experience to each damage point, a single rating designation can be calculated to indicate the approximate level of repairs required for the container.

The shipping container inspection system 10 can thus conduct condition assessment and prediction. The condition assessment module 524 is in accordance with the industry standard and uses the outputs from the “damage detection” and “corrosion detection and quantification.” A fuzzy logic-based condition rating is applied. Condition prediction of module 529 can be based on statistical analysis. Each shipping container can be characterized by a feature vector consisting of its condition rating, number of years in services, travel distances, and working conditions etc. A comprehensive database comprises the collected data from shipping containers. The prediction is achieved by clustering the new input with the data in the database 520.

Maintenance scheduling and repair operations on the shipping container can thus be planned, based on the continuous tracking of the container's physical condition. The historical data records and planned future container usage is stored and maintained such that the inspection system 100 can provide customizable information to support management decisions for scheduling of container maintenance, thereby minimizing the downtime and maximizing the availability of the containers. The accumulated container image data provides solid evidence to support necessary business decisions resulting in a cost effective, efficient and robust management of container shipping.

### CONCLUSION

Some of the benefits of the proposed shipping container inspection system and method are as follows: identification and assessment of container damages with focus on those representing health and safety issues; reducing turn around time by machine inspection of exiting and entering container traffic, limiting worker inspections to serious issues only; prediction of deterioration and pro-active repair cost budgeting, scheduling and routing of shipping containers to a plan which includes executing repairs in locations chosen to suit owners' best interests.

While the above description provides examples of the embodiments, it will be appreciated that some features and/or functions of the described embodiments are susceptible to modification without departing from the principles of the operation of the described embodiments. Accordingly, what has been described above has been intended to be illustrative and non-limiting and it will be understood by persons skilled in the art that other variants and modifications may be made without departing from the scope of the invention as defined in the claims appended hereto.

1-51. (canceled)

52. An automated inspection method for assessing a physical condition of a shipping container, the method comprising:
analysing, using at least one processor, a plurality of images, each image including at least a portion of one of the shipping containers' underside, rear, front, sides and/or top;
detecting a container identification code appearing in at least one of said images;
identifying, based at least on said plurality of images, characteristics of the shipping container and assessing the physical condition of the shipping container based on said characteristics, the container code and characteristics being determined by machine learning algorithms previously trained on shipping container images captured in various lighting and environmental conditions, wherein detecting the container code and characteristics of the shipping container is performed using a framework for image classification comprising convolutional neural network (CNN) algorithms;
associating the container code with said physical condition of the shipping container;
continuously logging said physical condition of the shipping container over time and predicting degradation of said condition of the shipping container as a function of time; and
transmitting container inspection results to a terminal operating system.

53. The method according to claim 52, comprising a step of scheduling maintenance and repair operations on the shipping container, based on said physical condition determined.

54. The method according to claim 53, wherein identifying characteristics of the shipping container comprises identifying damages, labels, security seals and placards, the method comprising a step of training the CNN algorithms to identify said damages, labels, placards and security seals using a respective damages, labels, placards and security seals training dataset, and categorizing the damages, labels, placards and security seals according to predefined classes.

55. The method according to claim 52, comprising classifying the identified shipping container damages and wherein the inspection results transmitted to the terminal operating system are provided according to ocean carrier guidelines, including the Container Equipment Data Exchange (CEDEX) and/or Institute of International Container Lessors (IICL) standards.

56. The method according to claim 52, wherein detecting the container code comprises comparing horizontal container code characters recognized in one of the images wherein the container code is displayed horizontally, with vertical container code characters recognized in another one of the images wherein the container code is displayed vertically, to increase accuracy of the container code determination.

57. The method according to claim 56, wherein each character forming the container code displayed vertically is isolated, and wherein the CNN algorithms comprise a mask algorithm to process each individual character separately, and then recognize the container code at word level.

58. The method according to claim 57, wherein the container code displayed vertically is first detected and cropped, and rotated by 90 degrees in a cropped and rotated image, displayed as a horizontal array, the convolutional neural network (CNN) algorithm recognizing the container code from the cropped and rotated image, by scanning and processing every alphanumeric character as a symbol to detect and identify the container code.

59. The method according to claim 52, wherein identifying characteristics of the shipping container comprises identifying a maritime carrier logo, dimensions of the shipping container, an equipment category, a tare weight, a maximum payload, a net weight, cubic capacity, a maximum gross weight, hazardous placards, height and width warning signs, top and bottom rail damages and deformations, door frame damages and deformations, corner post damages and deformations, door panels, side and end panels and roof panel damages and deformations, corner cast damages and deformations, door components damages and deformations, dents, deformations, rust patches, holes, missing components and warped components.

60. The method according to claim 52, wherein the inspection results are displayed on a graphical user interface, for allowing a terminal checker to validate the inspection results, and wherein feedback provided through the graphical user interface may be used for adjusting the machine learning algorithms.

61. The method according to claim 52, comprising capturing the plurality of images with high-definition fixed or mobile camera(s) located at truck and/or railway terminals, at least some of the plurality of images being extracted from at least one video stream.

62. The method according to claim 61, wherein the plurality of images is preprocessed locally by edge processing devices, the container code being detected and recognized by said edge processing devices, and the characteristics of the container are identified by said edge processing devices and/or remote cloud servers.

63. The method according to claim 60, comprising building a virtual coordinate system based on the Container Equipment Data Exchange (CEDEX) and associating coordinates with the container code and physical characteristics of the shipping container, according to said virtual coordinate system, to position said container code and/or physical characteristics in said virtual coordinate system.

64. The method according to claim 60, comprising rating the condition of the container according to a quality index.

65. The method according to claim 60, comprising using smart mobile devices to capture images and to augment visual imaging of terminal checkers by displaying information relative to the damages detected on the graphical user interface, based on said additional images.

66. An automated inspection system, for assessing the condition of shipping containers, the system comprising:
shipping container image storage for storing a plurality of images captured by digital cameras, each image including at least a portion of a given one of the shipping container's rear, front, sides and/or roof;
processing units and non-transitory storage medium comprising convolutional neural network (CNN) algorithms previously trained on shipping container images captured in various lighting and environmental conditions, the processing unit executing instructions for:
detecting container identification codes appearing in at least one of said plurality of images captured by the terminal cameras;
identifying, based at least on said plurality of images, one or more characteristics of the shipping containers and assessing the physical condition of the shipping containers, based on said characteristics identified, using the trained machine learning algorithms;
associating said container codes with said physical conditions of the shipping containers;
continuously logging said physical condition of the shipping container over time and predicting degradation of said condition of the shipping container as a function of time; and
transmitting container inspection results to a related database system; and
data storage for storing said processor-executable instructions and for storing said container codes, characteristics and conditions of the shipping containers.

67. The automated inspection system according to claim 66, wherein the non-transitory storage medium comprises a damage estimation module and a remaining useful life estimation module.

68. The automated inspection system according to claim 66, wherein the non-transitory storage medium comprises a horizontal code detection module, a vertical code detection module and a container code comparison module to identify and compare the container code displayed horizontally and vertically in selected ones of the images.

69. The automated inspection system according to claim 66, wherein the image storage means, and the processing unit comprises edge computing processing devices situated proximate to terminal premises.

70. The automated inspection system according to claim 66, wherein the data storage comprises a shipping container database, for storing information related to shipping containers, including at least one of: container codes; labels, security seals, and placards models; types of shipping containers and associated standard characteristics, such as width, length and height, the inspection results being stored according to ocean carrier guidelines, including the Container Equipment Data Exchange (CEDEX) and/or Institute of International Container Lessors (IICL) standards.

71. The automated inspection system according to claim 66, comprising a graphical user interface, for allowing a terminal checker to validate the inspection results, and wherein the non-transitory storage medium comprises instructions for causing the processor to adjust the machine learning algorithms based on the validation.
